(19) United States
(12) Patent Application Publication
(10) Pub. No.: US 2007/0043186 A1
(43) Pub. Date: Feb. 22, 2007

(54) Macrocyclic metal complexes and their uses as polymerization catylysts

(76) Inventors: Zhibin Guan, Irvine, CA (US); Drexel H. Camacho, Irvine, CA (US)

Correspondence Address: STOUT, UXA, BUYAN & MULLINS LLP, 4 VENTURE, SUITE 300, IRVINE, CA, 92618, US

(21) Appl. No.: 10/567,712

(22) PCT Filed: Aug. 6, 2004
(86) PCT No.: PCT/US04/25586

§ 371 Date: Oct. 23, 2006

Related U.S. Application Data
(60) Provisional application No. 60/493,519, filed on Aug. 7, 2003.

(51) Int. Cl. C09B 55/00; C08F 4/80; C07F 15/02

(52) U.S. Cl. 526/171; 556/126; 556/33

(57) ABSTRACT

Compositions comprising cyclophane metal complexes, methods for polymerization using such cyclophane metal complexes as catylysts and polymer compositions produced by such methods. Examples of polymers that may be manufactured by these methods incude polyethylenes and polyolefins. The cyclophane metal complexes of this invention are stable at high temperatures and thus may be used to catalyze polymerization reactions that occur fully or partially at high temperatures (e.g., temperatures above 50° C.).

### RELATED APPLICATION

This patent application claims priority to U.S. Provisional Patent Application Ser. No. 60/493,519 filed on on Aug. 7, 2003, the entirety of which is expressly incorporated herein by reference.

### FIELD OF THE INVENTION

This invention relates generally to chemistry and polymer science and more particularly to metal complexes useable as polymerization catalysts and the resultant polymers.

### BACKGROUND

Transition metal complexes of certain diimine ligands have been disclosed previously. Some of those. previously described transition metal complexes have been reported to be active as polymerization catylists. However, when used. for olefin catalysis, those previously described transition metal complexes typically exhibit low thermal stability and are thus not useable in the production of high molecular weight polymer at high temperatures.

There remains a need in the art for the development of new transition metal complexes that catalyze olefin polymerization and are stable at the high temperatures that typically result from the polymerization: of high molecular weight polymers.

### SUMMARY OF THE INVENTION

The present invention provides macrocyclic metal complexes having General Formula I, as follows: 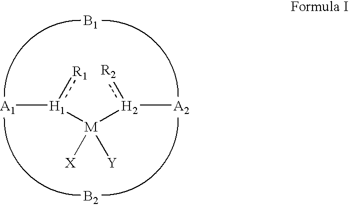
wherein;
A₁, and A₂ may be same or different and is a saturated or unsaturated, substituted or unsubstituted, chiral or achiral cyclic ring structure, for example a cycloalkyl or 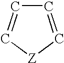
where Z is selected from O, NR₃, S, CR₆═CR₇, CR₆═N and N═CR₆ and when R₆ and R₇ are H, then the ring may be optionally substituted with one or more substituents, Q, selected from H, alkyl, alkoxy, amino, carboxy, cyano, halo, hydroxy, nitro and trifluoromethyl and R₆ and R₇ may further combine to form a cyclic ring, optionally substituted with one or more heteroatoms selected from O, N and S and may contain at least one doublebond;
B₁ and B₂ may be same or different and are selected from —Ar-T-Ar-T-Ar-T and -T- wherein Ar is an aromatic ring (for example, phenyl, furyl, thienyl, pyrrolyl, indolyl, isoindolyl, pyridyl, naphthyl, etc.);
T is a saturated or unsaturated, cyclic or acyclic; chiral or achiral hydrocarbon group with from 1 to 10 carbon atoms and wherein one or more of said carbon atoms in T may optionally be replaced with one or more heteroatoms or groups selected from O, S, SO, SO₂, NR₃, where R₃ is H, alkyl (C1-4), cycloalkyl (C3-6), aryl, aralkyl and acyl (C2-6); or (SiR4R5)n, where n is 1 or 2 and
—Si(R₄R₅)—O—Si(R₄R₅)—, where R₄ and R₅ may be same or different and are selected from alkyl (C1-4), cycloalkyl (C3-6), aryl and aralkyl;
H₁ and H₂are independently selected from any one of the the heteroatoms comprising N, P, O and S and these heteroatoms can be either in neutral form or exist as the corresponding anion when protons linked to said heteroatoms are removed;
R₁ and R₂, connected to H₁H₂ through either a single bond, a double bond or a combination of both, may be same or different and are selected from alkyl aryl, aralkyl, optionally substituted with alkyl, alkoxy, amino, carboxy, cyano, halo, hydroxy, nitro and trifluoromethyl or R₁ and R₂ may combine through an alkylene or substituted alkylene bridge to form a cyclic ring in case of bidentate ligands, examples of which are shown in FIGS. 4A-4E and discussed herebelow, and one or more methylene groups of said alkylene bridge may be substituted with an heteroatom, G, selected from O, P, S and N or an heterocyclic ring containing such an heteroatom in case of tridendate ligands, examples of which are shown in FIGS. 5A-5B and discussed herebelow.
R′ and R″ are alkyl, alkenyl, aryl, aralkyl and cycloalkyl;
X and Y are selected from halogens, pseudo-halogens, carboxylic acid esters, amino, substituted amino, alkoxy or aryloxy group; and
M is a transition group metal ion or a main group metal ion and is selected based on the type of ligand and comprise Fe, Ru, Os, Rh, Ir, Ni, Pd, Pt, Cu, Zn, Al, Ti , Zr, Hf, V, Nb, Ta, Cr, Mo and W, examples of which are shown in FIGS. 6A-6C and discussed herebelow.
   Furthermore, when B₁, B₂, A₁ and A₂ comprise phenyl rings then the linkages from B₁ to B₂ to A₁ to A₂to B₁are preferably through either 1,3 or 1,4 positions or a combination thereof of each ring moiety and when B₁, B₂, A₁ and A₂ comprise a heterocyclic ring then-the linkages may be through any of C2-C₅ in a five membered ring and through any of C₂-C₆ in a six membered ring.

Further in accordance with the present invention, the macrocyclic metal complexes may comprise cyclophane metal complexes for example cyclophane based Ni^{II}-α-diimine complexes.

Further in accordance with the present invention, there are provided copositions of matter having General, Formula I above, wherein B₂ is absent, such composition being “half complexes” of General Formula II, as follows:

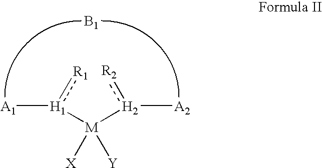

Still further in accordance with the present invention, the complexes of the present invention include a cyclophane-based Ni^{II}-α-diimine complex having the Formula III as follows:

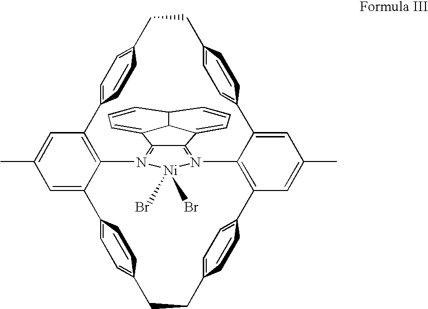

Still further in accordance with the present invention, there are provided methods for synthesizing polymers, such as polyethylenes and polyolefins, by reacting monomers and/or prepolymers in the presence of one or more complexes of General Formula I, II or III above.

Still further in accordance with the present invention, there are provided polymers, including but not limited to polyethylenes and polyolefins, that have been synthesized by reacting monomers and/or prepolymers in the presence of one or more complexes of General Formula I, II or III above.

Still further aspects and elements of the present invention will become apparent to those of skill in the relevant art upon reading of the detailed description and examples set forth below.

### BRIEF DESCRIPTION OF THE DRAWINGS

FIG. 1 shows diagrams comparing the acyclic (A) with cyclophane-based (B) Ni^{II}-α-diimine complexes.

FIG. 2 is a scheme for synthesis of a cyclophane-based (B) Ni^{II}-α-diimine complex of the present invention.

FIG. 3 is a table summarizing polymerization data describe herein.

FIGS. 4A-4E show the chemical structures of a number of bidentate ligands of the present invention.

FIGS. 5A-5BE show the chemical structures of a number of tridentate ligands of the present invention.

FIGS. 6A-6C are structural diagrams showing examples of the preference of metals for different types of ligands useable in the preparation of the complexes of the present invention.

FIG. 7 is a schematic showing of the use of a Brookhart catalyst (1) of the prior art in a polyolefin polymerization reaction.

FIG. 8 shows the chemical structure of an Ni-cyclophane diimine catalyst (2) of the present invention.

FIG. 9 is a schematic diagram of an experiment wherein 1-hexene was polymerized in the presence of a Ni-cyclophane diimine catalyst of the present invention and two prior art catalysts, to form poly(1-hexene) polymers.

FIG. 10 is a table setting forth catalyst activity and polymer molecular in the experiment of FIG. 9.

FIG. 11 is a graph comparing the catalytic activities of a Ni-cyclophane diimine catalyst of the present invention and two prior art catalysts, at various temperatures, in the experiment of FIG. 9.

### DETAILED DESCRIPTION

The present invention provides transition metal catalysts that are relatively stable at high temperatures and are useable to produce high molecular weight olefin polymers at high temperature. The improved temperature stability of these catalysts renders them useable for various types of olefin polymerization processes, including industrial gas phase olefin polymerization processes.

Examples of catalysts of the present invention may be formed by the complexation between a new cyclophane-based ligand with Ni(II) and other transition metal ions. As described in Section A of the detailed description set forth herebelow, the catalysts of the present invention show very high activity for ethylene polymerization to produce high molecular weight polymers. Also, as described in Section B of the detailed description set forth herebelow, the catalysts are also active in polymerizing α-olefins. An important attribute of the new catalyst is its high thermal stability which makes it suitable for industrial gas phase polymerization processes. This catalyst can be used. in manufacturing polyolefins as plastics and/or elastomers.

A. Synthesis and Use of The Compositions of the Present Invention in High Temperature Polyethylene Polymerization

Recently, late, transition metal olefin polymerization catalysts have been reported to be useable to produce polyolefins having new-branching topologies and improved tolerance to functional groups.¹ One such system is the Ni^{II}- and Pd^{II}-α-diimine complexes reported by Brookhart and coworkers.² These Ni^{II} systems have been shown to have comparable activities to those of the early metal catalysts in polymerizing ethylene into high molecular weight (MW) polyethylenes (PEs) and the Pd^{II} systems were shown to be able to incorporate functional olefins such as methyl acrylate.² The branching topology of the PEs formed by the Pd^{II}-α-diimine catalysts was able to be tuned from linear to hyperbranched to dendritic by simply varying ethylene pressure.³ Although the late transition metal olefin polymerization catalysts of the prior art may exhibit desirable properties, one severe limitation is their high sensitivity to temperature. The catalysts decompose rapidly at 50° C. for Pd^{II} systems^{4a} and at 70° C. for Ni^{II} systems.^{4b} The MW of the PEs formed by Ni^{II} catalysts also decreases precipitously as the temperature of polymerization is raised. 4b These issues significantly hindered the commercialization of these catalysts because gas phase olefin polymerizations are typically operated at 80-100° C.⁵

As described in this patent application, applicants have invented new cyclophane-based Ni^{II}-α-diimine catalysts that show significantly improved thermal stability and produce high MW PEs at temperature ranges suitable for industrial gas phase olefin polymerization.

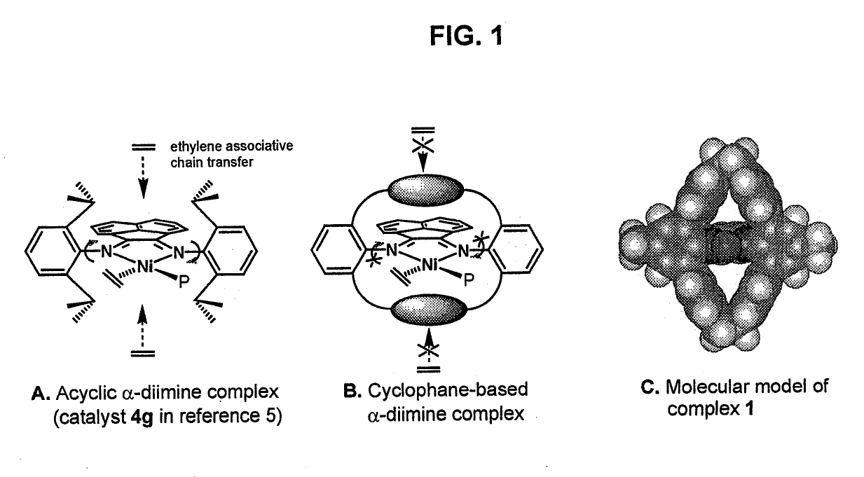

Cyclophane chemistry has evolved into an exciting research area starting from simple curiosity of its synthesis to the exploitation of its properties for various applications including molecular recognition, supramolecular chemistry and biomimics.⁶ It is interesting to note, however, that the use of cyclophanes as ligands in transition metal catalysis has not been well explored.⁷ We report here the first cyclophane-based transition metal complex for efficient ethylene polymerization at elevated temperatures (FIG. 1). In the acyclic catalyst (A) shown in FIG. 1, the aryl groups are roughly perpendicular to the coordination plane so the isopropyl substitutents on the aryls are positioned at the axial directions to block the associative chain transfer of ethylene.² At elevated temperature, however, the aryl groups may rotate away from the perpendicular orientation resulting in increased associative chain transfer and decreased MW for PE formed.^{4b} Moreover, as the aryl groups rotate toward the coordination plane, the isopropyl substituents on the aryl rings reach proximity to the metal center for C—H activation to form metallacycles, which was proposed as one potential deactivation pathway for this family of catalysts.^{4a} In the cyclophane-based complex (B) of the present invention, as shown in FIG. 1, the metal center is positioned at the core of the ligand so that the macrocycle completely blocks the axial faces of the metal leaving only two cis-coordination sites for monomer entry and polymer growth. The rigid framework of the ligand prohibits free rotation of the aryl-nitrogen bonds, which should allow the catalyst to make high MW polymers at elevated temperature. The lack of rotational flexibility makes the C—H activation to the ortho substituents impossible, therefore, should shut off this potential catalyst deactivation pathway. It has also been observed for other systems that rigid macrocyclic ligands could enhance the coordination stability for metal complexes.^{7b} Based on these considerations, applicants have designed the cyclophane-based α-diimine ligand to address the critical thermal sensitivity issues of the acyclic α-dimine, systems. In a more general term, we envision cyclophanes as a new family of ligand frameworks in designing metal complexes for catalysis.

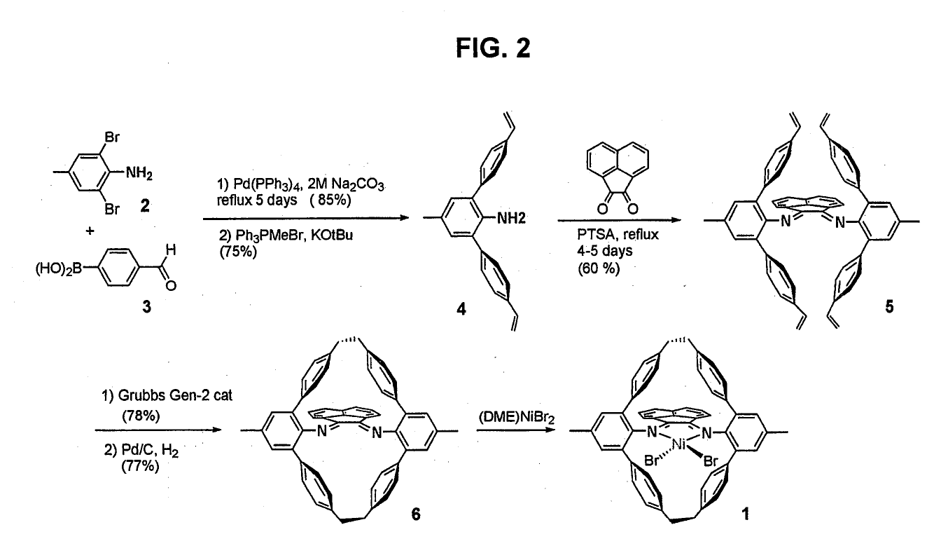

As shown in FIG. 2, the synthesis of the cyclophane ligand may began with Suzuki coupling of the commercially available 2,6-dibromo-4-methylaniline 2 and 4-formylphenylboronic acid 3 followed by conversion of the dialdehyde to divinyl via Wittig reaction to give the product 4 in 64% total yield. Condensation of 4 with acenaphthenequinone gave the α-diimine 5, which was cyclized via ring closing metathesis⁸ followed by hydrogenation to give the cyclophane α-diimine 6. Complexation of 6 with (DME)NiBr₂ in dicholoromethane afforded the final NiBr₂ complex (1) as the precatalysts for the following ethylene polymerization studies.

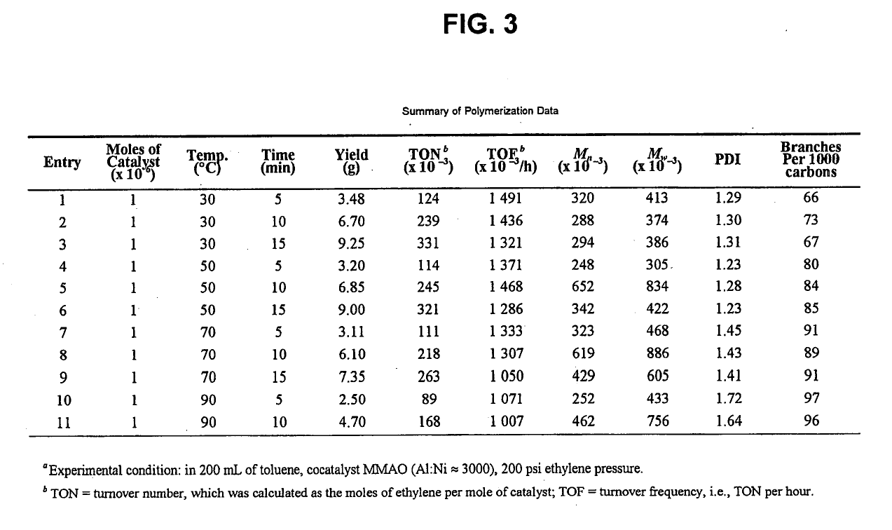

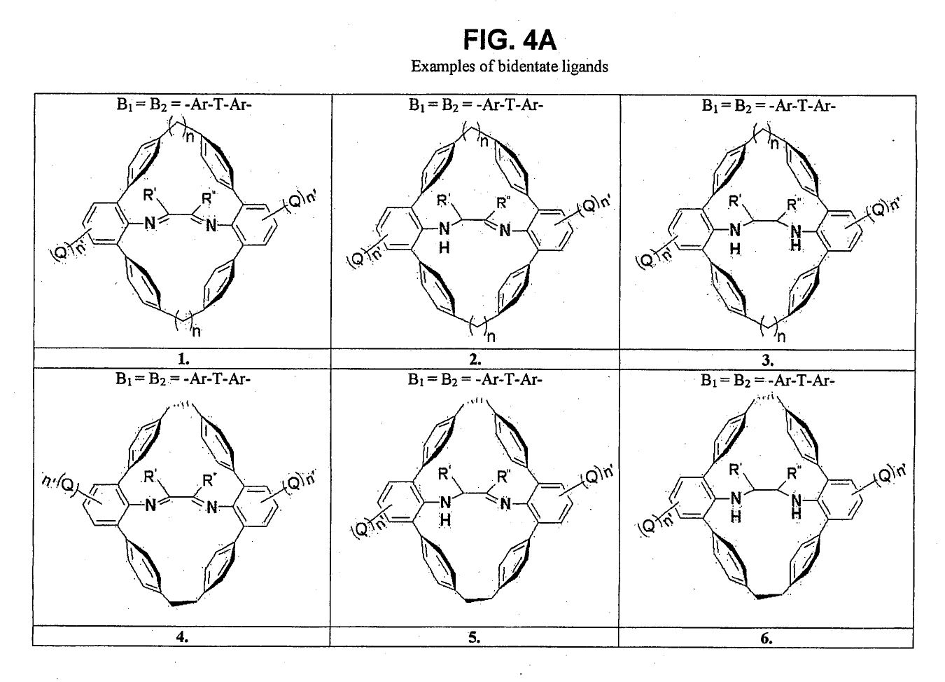

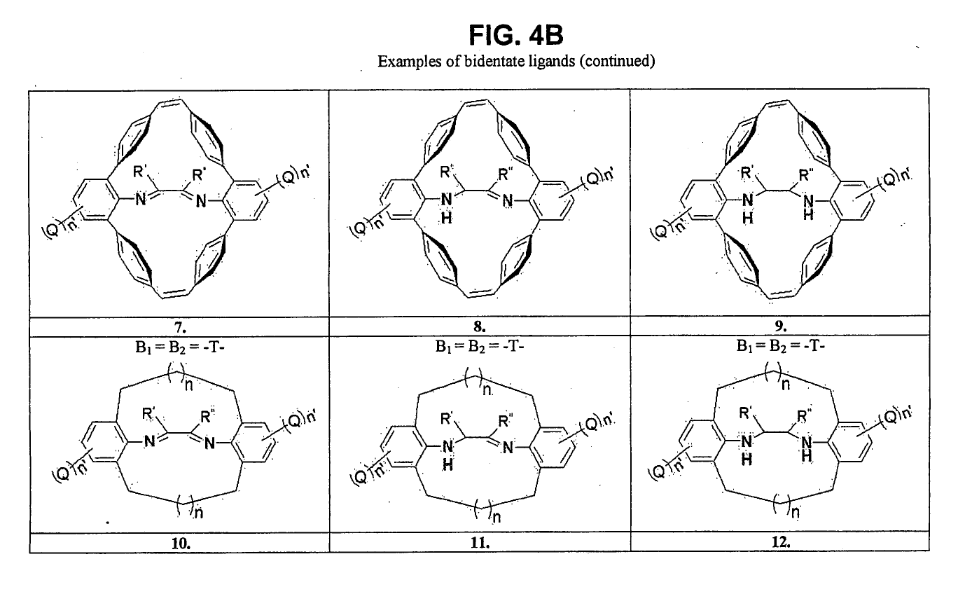

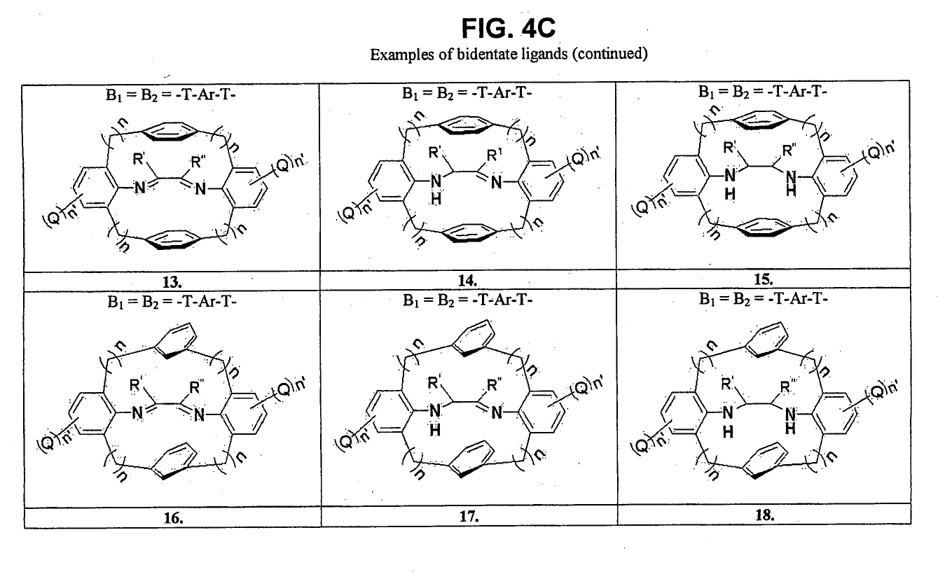

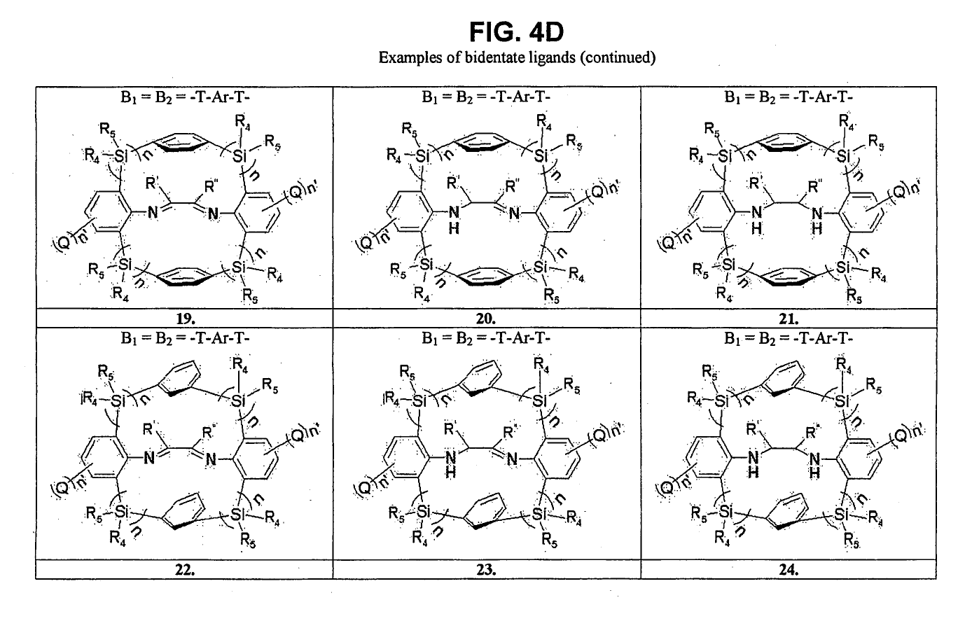

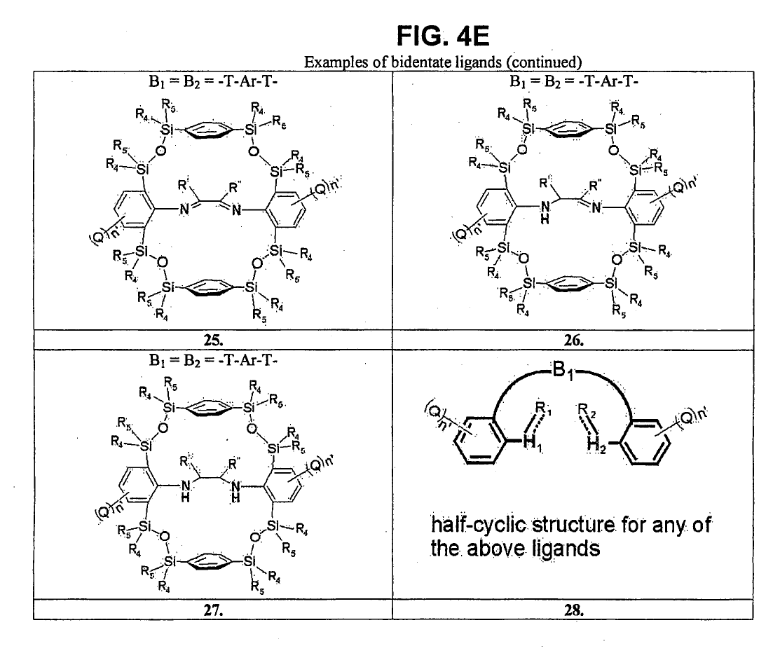

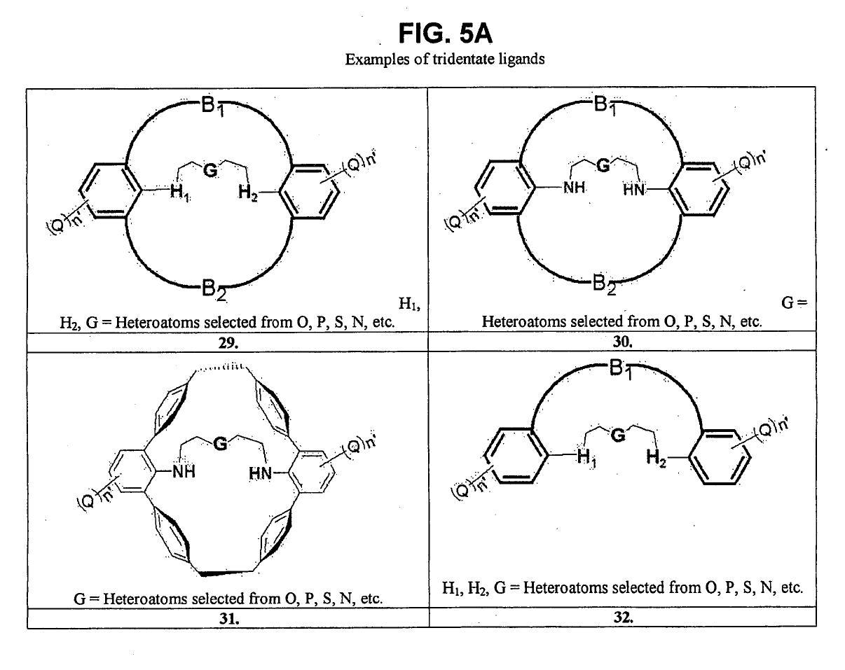

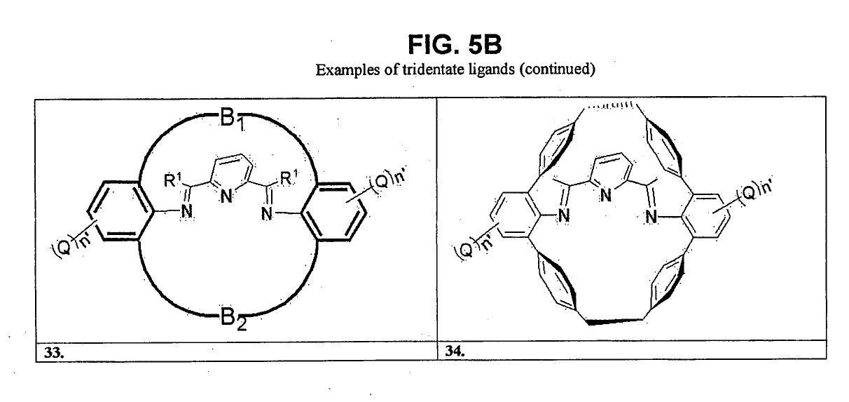

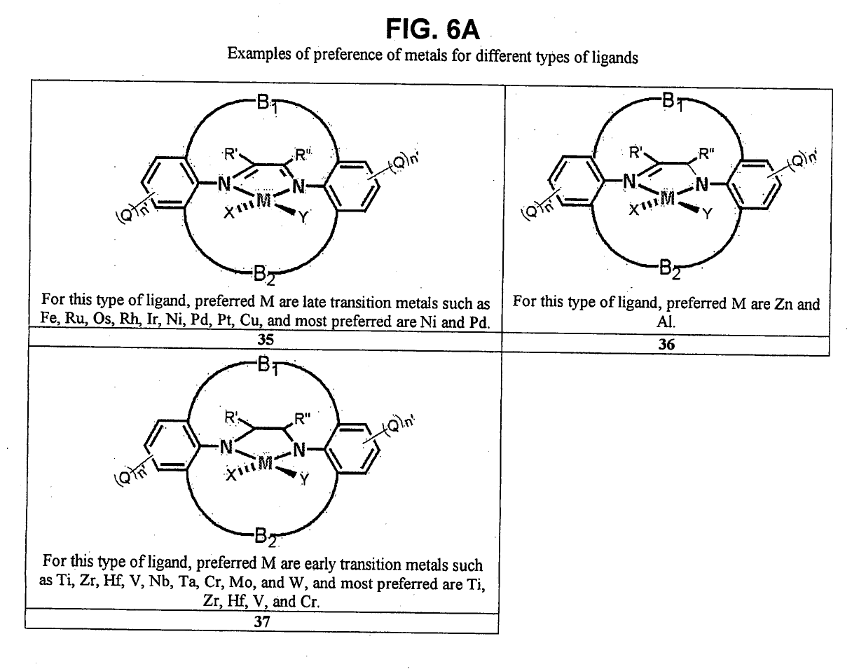

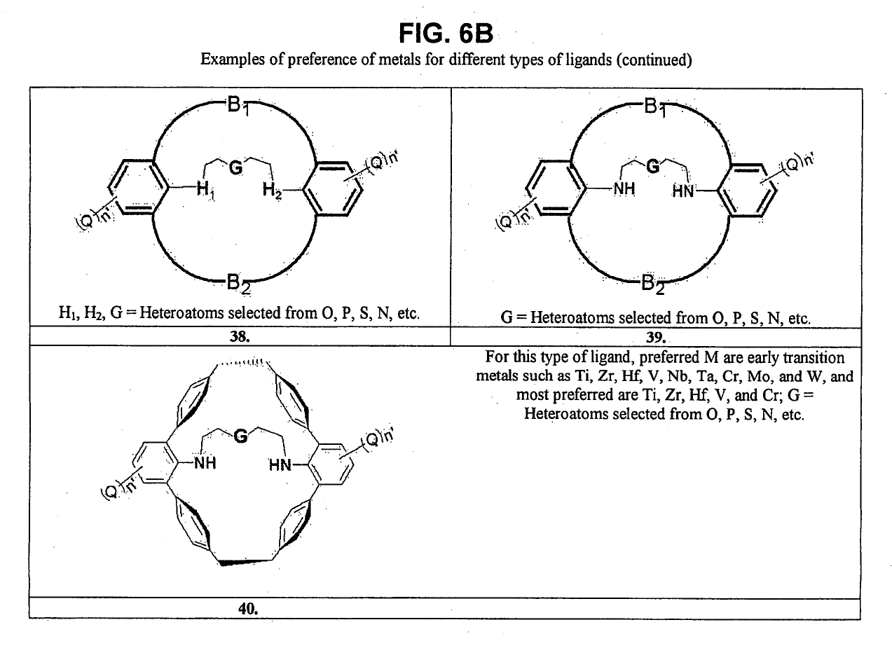

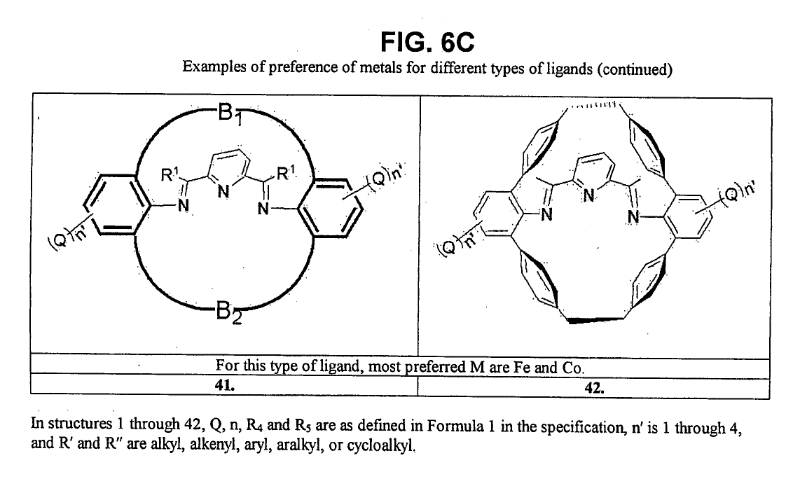

A space-filling molecular model (C) for complex (1) is shown on the far right in FIG. 1. As shown, the active Ni^{II} center is right in the core of the cyclophane ligand.⁹ Top-view of the molecular model indicates that the axial faces of the metal center are completely blocked by the cyclophane ring. Complex (1) (FIG. 2) was activated in toluene, with modified methylaluminoxane (MMAO) for ethylene polymerization at various temperatures and times as summarized in the table of FIG. 3.

Exposure of the complex (1) of FIG. 2 to MMAO in toluene resulted in a highly active catalyst for ethylene polymerization. The activated catalyst showed ethylene polymerization activity similar to the most active early transition metal catalysts¹⁰ and late-transition-metal catalysts^{2a,4b,11} with the turnover frequency (TOF) of 1.5×10⁶/h (equivalent to productivity of 42,000 kg(PE)·[mol(Ni)·h]⁻¹). The polymerization was run at 30° C.-90° C. to test its thermal stability. At each temperature, the polymerization was run for three different periods of time ranging from 5 to 15 min to test the catalyst lifetime. The data show that the catalyst remained highly active at temperatures up to 90° C. Importantly, as the temperature was increased from 30° C. to 70° C., the observed TOF decreases only by <10% for 10 min polymerization (entry 2 & 8). Even at 90° C., the reduction of TOF for polymerization of 10 min is less than 30% (entry 2&11). This is in sharp contrast to the acyclic Ni^{II}-α-diimine counterparts (e.g., 4 g in reference 5); which generally show a precipitous drop in activity at 60° C.-85° C.^{4b} The calculated TOF's for polymerization at constant temperature but different periods of time indicate that the active catalyst remained active for a significant period of time. At temperatures below 70° C., the catalyst maintained nearly constant productivity in 15 minutes. For polymerizations at 70° C. and 90° C., the productivity was constant in the first 10 minutes and then starts to decrease at even longer time, suggesting that the active species starts to deactivate at longer time at high temperature.

The MWs of the PEs obtained using complex (1) of FIG. 2 likewise did not drop as the temperature was raised. This again contrasts to the acyclic Ni^{II}-α-dimine, systems, for which MWs of PEs usually decrease rapidly with increasing temperature.^{4b} The observed monomodal molecular weight distribution and relatively narrow polydispersity indices (PDI) indicates the single-site nature of the catalyst. The PEs formed contain short chain branches with most being simple methyl branches as revealed by ³C NMR. The branching density increases as the polymerization temperature increases, which is consistent with the acyclic N^{II}-α-dimine systems. The branching density is comparable to PEs produced by bulky acyclic Ni^{II}-α-dimine systems at similar conditions. The branching was presumably produced by the chain-walking mechanism proposed by Brookhart ² and Fink.¹²

In summary, a novel cyclophane-based Ni^{II}-α-dimine complex (1) of the present invention was shown to be a very effective ethylene polymerization catalyst upon activation with MMAO. The new catalyst exhibits sufficiently high thermal stability for temperature ranges suitable for gas-phase olefin polymerization processes. The MWs of the PEs formed are high and rather constant with polymerization temperature. We are currently investigating the polymerization properties of a family of new cyclophane-based transition-metal complexes.

Details of syntheses and characterization for the ligand, complex and polymers used in the above-described experiments, as well as the supporting references relating to footnotes set forth in the forgoing Section A of this Detailed Description, are provided in Appendix A to this patent application

B. Synthesis and Use of the Compositions of the Present Invention in High Temperature Polyolefin Polymerization

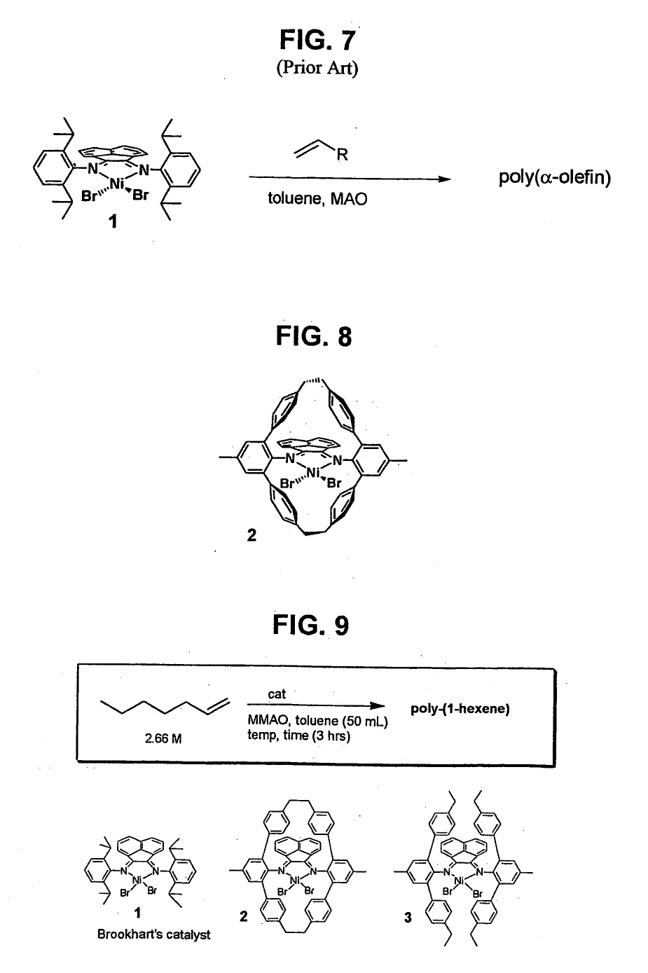

The following paragraphs relate to FIGS. 7-18 and the reference numerals set forth in the following paragraphs relate to the reference numerals labeled on FIGS. 7-11.

FIG. 7 shows, in equation format, the use of a nickel catalyst (1) derived from acyclic diimine ligand system activated by methylaluminoxane (MAO) for the polymerization of α-olefins.ⁱ These prior art catalysts along with the Pd catalyst systemⁱⁱ are reportedly-more robust in polymerizing α-olefins at room temperature and exhibit living polymerization only at lower temperatures (0 to −10° C.). These reports have, however, been silent about the possible activity of the catalyst at higher than ambient temperature presumably due to the observed deactivation of the catalyst at 50° C. in ethylene atmosphere.ⁱⁱⁱ

Applicants have developed the macrocyclic Ni-α-diimine complex^{iv} (2) shown in FIG. 8 and have shown such complex (2) to be an efficient catalyst for ethylene polymerization at high temperature^{v} even surpassing the activity and stability of the original acyclic diimine catalyst (1) developed by Brookhart^{vi} and shown in FIG. 7.

In continuation of the study on exploring the activities of the macrocyclic complex (2) shown in FIG. 8, polymerization attempts were made on α-olefin and copolymerization with polar comonomers.

a) Polymerization of 1-Hexene Using Ni-Cyclophane Complex

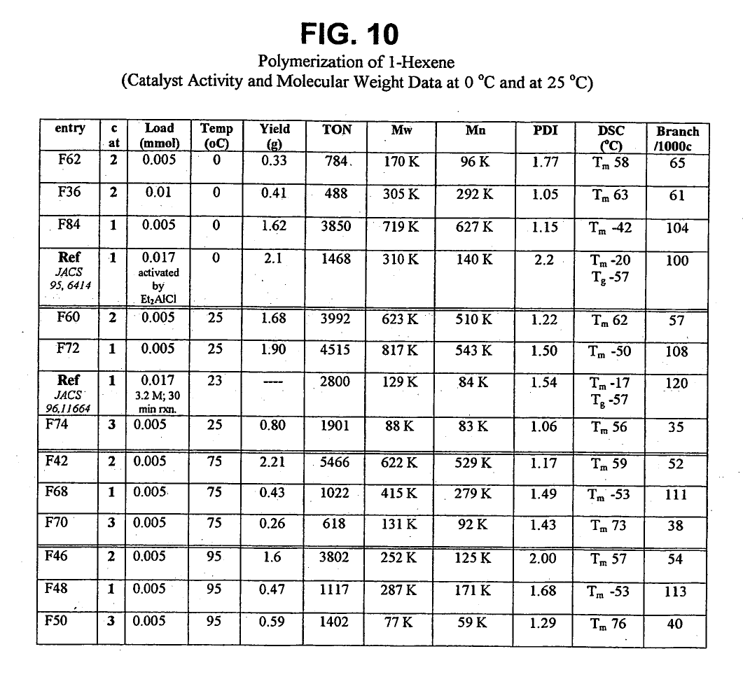

As shown in FIG. 9, the activity of an Ni-cyclophane diimine catalyst (2) of the present invention on polymerizing α-olefins was tested on 1-hexene and was compared with Brookhart's catalyst (1) and another acyclic Reiger-type catalyst (3). The results of this comparison are shown in the table of FIG. 10.

The initial experiments were done at 2.66 M concentration of 1-hexene in toluene and the thermal stability was compared at temperatures 0, 25, 75 and 95° C. The polymerization data at 0° C. indicate that the cyclophane catalyst (2) (TON=488 to 784) is less active than the Brookhart catalyst (1) (TON=1468 to 3850). The low activity of the cyclophane catalyst (2) of the present invention at 0° C. is not well understood but could be attributed to a sluggish activation of the catalyst. It could also be attributed to the very bulky and cyclophane microstructure of the catalyst (2) which could interfere with the ease of approach of the α-olefin monomer at 0° C. The low temperature condition gave low molecular weight poly(1-hexene) compared to entries F84 and the Brookhart data.

The same trend can be observed when the cyclophane catalyst (2) of the present invention is compared with the Brookhart catalyst (1) at room temperature. The bulky acyclic Reiger-type catalyst (3) demonstrated much lower activity with low molecular weights.

b) Catalyst Activity and Molecular Weight Data at 75° C. and 95° C.

The polymerization at higher temperature generally shows that the cyclophane catalyst (2) of the present invention is more active than the acyclic catalysts (1) and (3) of the prior art. The 1-hexene monomer boils at 64° C. thus at the temperatures of 75° C. and 95° C., it is refluxing and mostly in the gaseous phase. The polymerization shows that at 75° C., the cyclophane catalyst (2) of the present invention gave more polymers and even exceeded its own performance at room temperature (from TON 3992 at RT to TON 5466 at 75° C.) while maintaining its molecular weights (Mw˜622 K). This is in contrast to the sudden drop in activity of the Brookhart catalyst (1) (from TON 4515 at RT to TON 1022 at 75° C.) and of the Reiger-type catalyst (3) (from TON 1901 at RT to TON 618 at 75° C.) along with their drops in molecular weight. The observed lower activities of the acyclic catalysts are in accord with the thermal instability that causes catalyst deactivation as previously noted. The cyclophane architecture indeed improves the thermal stability of the Ni-diimine catalyst.

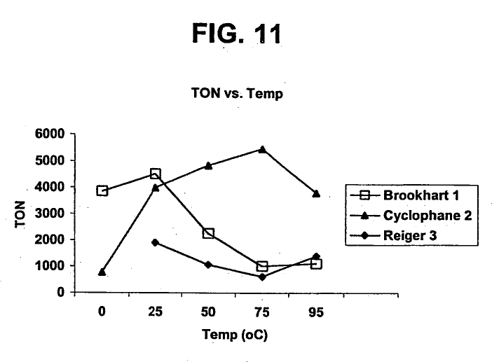

The graph in FIG. 11 shows the comparison of thermal stability between the cyclophane catalyst (2) of the present invention and the acyclic catalysts (1) and (3) of the prior art. The cyclophane catalyst (2) clearly exhibits superior catalytic activity at higher temperatures. The observed lower polydispersity of the polymer produced by the cyclophane catalyst (2) at 75° C. (PDI=1.17) compared to the acyclic catalysts (PDI=1.43-1.49) may suggest some living polymerization activity. Thus to test this observation, living polymerization experiment at 75° C. was done where aliquots are collected at 20 minute intervals and molecular weight data were measured using GPC. The raw data is shown in the table of FIG. 12 and a corresponding graph of molecular weight vs. time is shown in FIG. 13. These results indicate that the system at 75° C. is living for the first hour as shown by the increasing molecular weights (reaching a million at 60 minutes) while roughly maintaining its polydispersity. Beyond one hour however, the molecular weights decrease. This could be attributed to the depletion of the monomer feed at longer time.

Details on the materials, preparations and procedures used in these experiments, as well as the supporting references relating to the footnotes set forth in the forgoing Section B of this Detailed Description, are provided in Appendix B to this patent application.

Is is to be appreciated that the invention has been described hereabove with reference to certain examples or embodiments of the invention but that various additions, deletions, alterations and modifications may be made to those examples and embodiments without departing from the intended spirit and scope of the invention. For example, any element or attribute of one embodiment or example may be incorporated into or used with another embodiment or example, unless to do so would render the embodiment or example unsuitable for its intended use. All reasonable additions, deletions, modifications and alterations are to be considered equivalents of the described examples and embodiments and are to be included within the scope of the following claims.

### APPENDIX A

General

All manipulations of air and/or water sensitive compounds were performed using the standard Schlenk techniques. Organometallic compounds were handled in a nitrogen-filled Vacuum Atmospheres drybox. High-resolution mass spectra were recorded on Micromass LCT or Micromass Autospec. Elemental analyses were performed by Atlantic Microlab of Nocross, Ga. ¹H and ¹³C NMR spectra were recorded on Bruker Avance-500 or 400 spectrometers. Chemical shifts are reported relative to the residual solvent. ¹H NMR spectra of polyethylene were taken in C₆D₅Br at 140° C. using 10 s delay time. The degree of branching of the polyethylenes was estimated from the integrals of the methyl, methine and methylene groups as determined by ¹H NMR spectroscopy.¹ Gel Permeation Chromatography (GPC) was performed in toluene using Agilent LC 1100 Series equipped with Polymer Labotatory's PLgel 5 μm mixed-C column. A calibration curve was established with polystyrene standards.

Materials.

Toluene, dichloromethane and diethyl ether were purified using the procedure described by Pangborn et al.² High pressure polymerizations were performed in a mechanically stirred 600 mL Parr autoclave. Ultra high pure grade ethylene was purchase from Airgas and used without further purification. A 7% Al (wt %) solution of modified methylaluminoxane (MMAO) in toluene (d=0.88 g/mL) containing 12% isobutyl groups was purchased from Akzo Nobel. Acenaphtenequinone, 4-formylphenylboronic acid, 2,6-dibromo-4-methyl aniline, and methyltriphenyl-phosphonium bromide were purchased from Aldrich Chemical Co. (DME)NiBr₂ was purchased from Strem. C₆D₅Br was purchased from Aldrich and stored over activated 4 A° molecular sieves. The second generation Grubbs ruthenium carbene metathesis catalyst was generously donated by the Materia Inc.
Synthesis of 4: 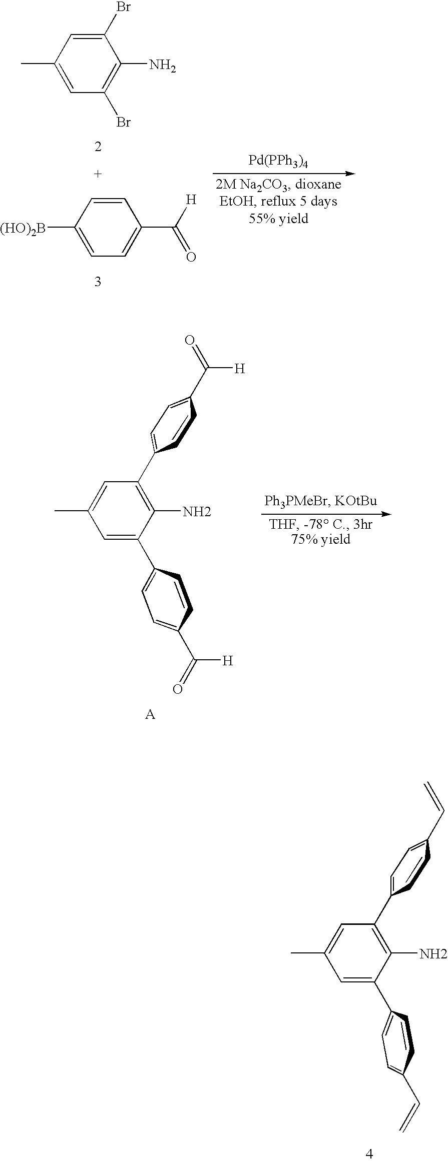
Synthesis of A.³

A mixture of 2,6-dibromo-4-methyl aniline 2 (15.9 g; 60 mmol) and Pd(PPh₃)₄ (8.32 g; 12 mol %) in dioxane, was stirred at 70° C. for 20 minutes. A solution 4-formylphenylboronic acid 3 (25 g; 3 eq), dissolved in a small amount of ethanol and dioxane, was added to the mixture followed by addition of 2M Na₂CO₃ (6 eq). The mixture was heated to reflux form 3 days. The organic layer was separated and the aqueous layer was extracted with ethyl acetate 3 times. All the organic layers were combined; dried over Na₂SO₄, and solvent was removed. The crude yellow product was subjected to column chromatography (silica, 2:1 hexane/EtOAc) to give the product A in 85% yield; ¹H NMR_{(CDCl3)}: δ 10.06 (s, 2H, —CHO); 8.0 (d, J=8.1 Hz, 4H, arom. H); 7.70 (d, J=8.1 Hz, 4H, arom. H); 6.96 (s, 2H, arom. H); 4.30 (s, 2H, —NH₂); 2.25 (s, 3H, —CH₃). ¹³C NMR: 192.7, 145.9, 138.9, 134.8, 130.8, 130.0, 129.8, 126.3, 126.2, 19.9 ppm.

Synthesis of 4.

To a solution of methyltriphenylphosphonium bromide (162 mmol; 58 g) in THF was added potassium tert-butoxide (178 mmol; 21 g) in three proportions with 15-minute interval between additions. The mixture was stirred for 1 hr at r.t. under argon. The solution was then cooled to −78° C. A solution of A (54 mmol) in THF was slowly added to the above solution via a dropping funnel. The mixture was stirred for 3 hours at −78° C. and then warmed to r.t. The reaction was finally quenched with water, extracted with ether, washed with brine, and dried over MgSO₄ to afford a crude product, which was chromatographed (silica 100:1 hexane/ethyl acetate) to give 4 as a yellow solid in 75% yield. ¹H NMR_{(CDCl3)}: δ 7.49 (s, 8H, arom. H); 6.95 (s, 2H, arom. H); 6.75 (q, J=17.6, 10.9 Hz, 2H, —CH═C); 5.79 (d, J=17.6, 0.7 Hz, 2H, trans terminal vinylic H); 5.27 (d, J =10.9, 0.7 Hz, 2H, cis terminal vinylic H); 3.74 (s, br, 2H, —NH₂); 2.30 (s, 3H, —CH₃). ¹³C NMR: 139.8, 138.8, 137.0, 136.9, 130.7, 129.9, 128.2, 127.8, 127.1, 114.4, 20.8 ppm. HRMS calcd for C₂₃H₂₁N: 311.1674; found: 311.1674. Anal. calcd for C₂₃H₂₁N: C, 88.71%, H, 6.80%; found C, 87.80%, H, 6.75%.
Synthesis of α-Diimine 5:^{4,5}

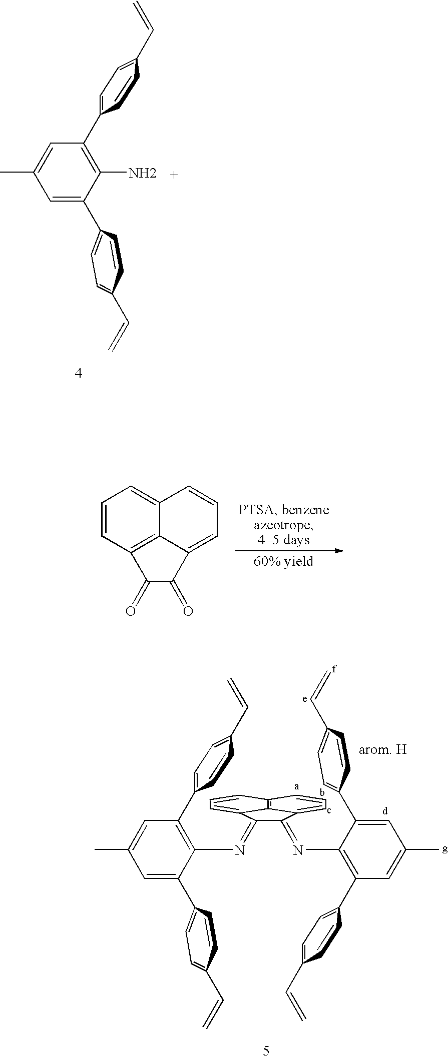

In a three-neck flask fitted with a Dean-Stark apparatus and a condenser, a mixture of acenaphthenequinone (15 mmol) and para-toluene sulfonic acid (0.25 mol %) in benzene (50 mL) was stirred under argon. A solution of 4 (2.5 equiv) in benzene was then added (a very small amount of 1,4 hydroquinone was added to prevent polymerization of the styryl double bonds). The mixture was heated to reflux for 5 days and the water byproduct was constantly removed by azeotrope. The volume of the solvent was then reduced under vacuum and the product was chromatographed (silica, Hexane) to give the 5 as an orange solid in 60% yield. ¹H NMR: δ 7.51 (d, J=8.3 Hz, 2H, a); 7.40 (d, J=8.3 Hz, 8H, arom. H); 7.20 (s, 4H, d); 7.15 (pseudo t, 2H, b); 7.00 (d, J=8.3 Hz, 8H, arom. H); 6.76 (d, J=7.2 Hz, 2H, c); 6.53, (m, 4H, e); 5.58 (d, J=17.6, 0.8 Hz, 4H, f); 5.10 (d, J=11.6, 4H, f); 2.47 (s, 6H, g). ¹³C NMR: 161.0, 144.9, 140.6, 140.0, 137.1, 136.1, 134.6, 131.6, 131.4, 130.7, 130.1, 130.0, 128.5, 127.6, 126.1, 122.8, 113.8, 21.43 ppm. HRMS calcd for [C₅₈H₅₄N2+H]⁺: 769.3583; found: 769.3599.
Synthesis of Cyclophane α-Diimine 6: 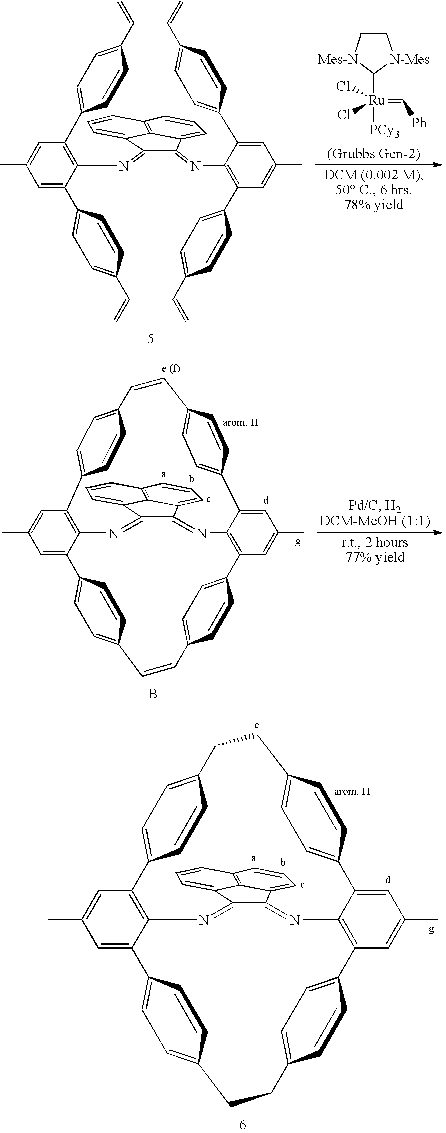
Synthesis of B.

A mixture of 5 (0.046 g; 0.06 mmol) and the second generation Grubbs metathesis catalyst (6 mol %) in CH₂Cl₂ was stirred at 50-60° C. under nitrogen atmosphere.⁶ The reaction was monitored by ESMS. After cooling, the solution was filtered through Celite. Evaporation of the solvent gave the yellow solid, which was chromitographed (silica, hexane/CH₂Cl₂=1:1) to give the product B in 78% yield. ¹H NMR δ 7.86 (d, J=7.9 Hz, 2H, a); 7.42 (pseudo t, 2H, b); 7.33 (d, J=7.7 Hz, 4H, arom. H); 7.23 (s, 4H, d); 6.82-6.80 (overlapping, 10H: 4H for e/f, 4H for arom. H and 2H for c); 6.68 (d, J=7.7 Hz, 4H, arom. H); 6.48 (d, J=7.7 Hz, 4H, arom. H); 2.49 (s, 6H, g). ¹³C NMR: 162.2, 146.0, 140.5, 138.0, 137.3, 133.9, 133.4, 131.5, 131.3, 131.2, 130.6, 130.0, 129.8, 129.2, 129.1, 128.7, 128.0, 123.9, 21.4 ppm. HRMS calcd for [C₅₄H₃₆N₂+H]⁺: 713.2957; found: 713.2933.

Synthesis of 6.

A mixture of B (0.35 mmol) and Pd/C (10 mol %) in CH₂Cl₂/MeOH (1:1) was stirred for 2 hr under hydrogen atmosphere. The mixture was then filtered through Celite and the solvent was evaporated to give a yellow solid. The solid was subjected to column chromatography (silica, hexane/ethyl acetate/acetone: 7/3/0.5) to give the product 6 as a yellow powder in 77% yield. ¹H NMR: δ 7.86 (d, J=8.3 Hz, 2H, a); 7.44 (pseudo t, b); 7.28 (m; 4H, arom. H); 7.13 (s, 4H, d); 6.78 (d, J=7.9 Hz, 4H, arom. H); 6.72 (d, J=7.2 Hz, 2H, c); 6.54 (d, J=7.7 Hz, 4H, arom. H); 6.35 (d, J=7.7 Hz, 4H, arom. H); 2.94 (m, 4H, e or f); 2.79 (m, 4H, e or f); 2.45 (s, 6H, g). ¹³C NMR: 138.8; 138.0; 137.3; 137.3; 133.4; 131.6; 131.3; 130.6; 130.3; 129.8; 128.7; 127.9; 123.9; 123.8; 36.2; 21.5 ppm. UV/Vis_{(DCM)} λmax (nm) 262, 3029 412. HRMS calcd for [C₅₄H₄₀N₂+H]⁺: 717.3270; found: 717.3295. Anal. calcd for C₅₄H₄₀N₂: C, 90.47%, H, 5.62%, N, 3.91%; found C, 90.12%, H, 5.77%, N, 3.67%.
Synthesis of Complex 1:⁷

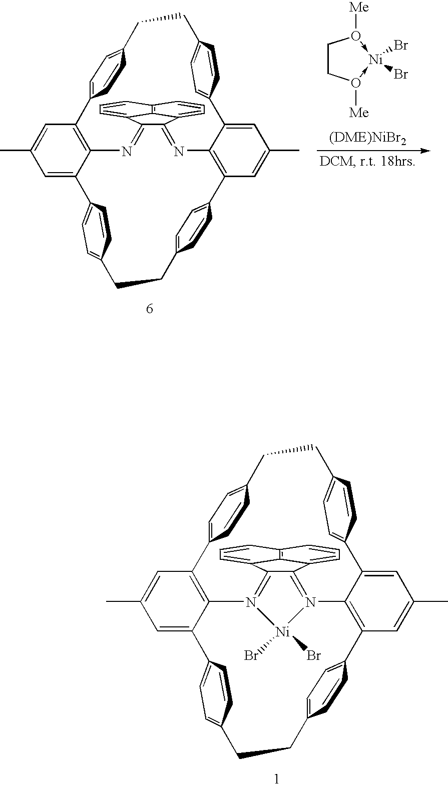

A mixture of 6 (0.28 mmol) and (DME)NiBr₂ in CH₂Cl₂ was stirred under nitrogen atmosphere. The solution turned from, yellow into dark green within 1 hr. The solution was stirred at r.t. for overnight. The solvent and the residual DME were removed under high vacuum for 24 hours to give a dark green powder. Due to the paramagnetic nature of the complex, satisfactory NMR spectra could not be obtained. The complex formation was confirmed by elemental analysis and the shift of UV/Vis absorption band from 412 nm for the ligand 6 to 548 and 608 nm for complex 1. UV/Vis_{(DCM)} λ max (nm) 292, 396, 548, 608. Anal. Calcd⁸ for C₅₄H₄₀Br₂N₂NiCH₂Cl₂: C, 64.74%, H, 4.15%, N, 2.75%; found C, 64.77%, H, 4.46%, N, 2.68%.

General Procedure: for polymerization:^{1,7}

A 600 mL Parr autoclave was heated under vacuum at 110° C. for several hours and was flushed with ethylene twice. It was then cooled to r.t. and backfilled with ethylene twice before reducing the pressure inside. Toluene (200 mL) and MMAO (1.6 mL; 3000 equiv), which were prepared inside the glovebox, were transferred into the Parr reactor under nitrogen stream. The autoclave was sealed and the ethylene pressure raised to 200 psi. The solution was vigorously stirred under ethylene pressure and the temperature of the system was equilibrated to be 5 degrees less than the desired polymerization temperature for 15 minutes. The autoclave was then vented and the pressure inside was reduced. The complex 1, which was dissolved in small amount of toluene, was transferred into the autoclave which was then sealed and pressurized to 200 psi ethylene pressure under vigorous stirring. Reaction was done at the specified reaction time maintaining the temperature (±3° C.). The autoclave was finally vented and a large amount of methanol/acetone was added to quench the polymerization and deactivate the residual MMAO. The precipitated polymers were collected and dried at 100° C. under vacuum.

References Footnoted in Appendix A:

1. Gates, D. P.; Svejda, S. A.; Onate, E.; Killian, C. M.; Johnson, L. K; White, P. S.; Brookhart, M. Macromolecules 2000, 33, 2320.
2. Pangborn, A B.; Ciardello, M. A.; Grubbs, R. H.; Rosen, H. K.; Timmers, F. J. Organometallics 1996, 15, 1518.
3. Miyaura, N.; Yanagi, T.; Suzuki, A. Synth. Commun. 1981, 11, 513.
4. van Asselt, R.; Elsevier, C. J.; Smeets, W. J. J.; Spek, A. L.; Benedix, R. Recl. Trav. Pays Bas 1994, 113, 88.
5. Schmid, M.; Eberhardt, R.; Klinga, M.; Leskela, M.; Rieger, B. Organometallics 2001, 20, 2321.
6. Scholl, M.; Trnka, T. M.; Morgan, J. P. Grubbs, R. H. Tet. Lett. 1999, 40, 2247.
7. Johnson, L. K; Killian, C. M.; Brookhart, M. J. Am Chem. Soc. 1995, 117, 6414.
Liimatta, J. O.; Löfgren, B.; Miettinen, M.; Ahlgren, M.; Haukka, M.; Pakkanen, T. T. J. Polym. Sci. A: Polym. Chem. 2001, 39, 1426.
   References Footnoted in Section A of Detailed Description
1. (a) Ittel, S. D.; Johnson, L. K.; Brookhart, M. Chem. Rev. 2000, 100, 1169-1203. (b) Gibson, V. C.; Spitzmesser, Stefan K Chem. Rev. 2003, 103, 283-315. (c)Younkin, T. R.; Connor, E. F.; Henderson, J. I.; Friedrich, S. K.; R. H. Grubbs, R. H.; Bansleben, D. A. Science 2000, 287, 460-462.
2. (a) Johnson, L. K.; Killian, C. M.; Brookhart, M. J. Am. Chem. Soc. 1995, 117, 6414-46415. (b) Johnson, L. K.; Mecking, S.; Brookhart M. J. Am. Chem. Soc. 1996, 118, 267-268.
3. (a) Guan, Z; Cotts, P. M.; McCord, E. F.; McLain, S. J. Science 1999, 283, 2059-2062. (b) Chen, G.; Ma, S. X. and Guan, Z. J. Am. Chem. Soc. 2003, 125, 6697-6704-6415. (c) Guan, Z. Chem.-Eur. J. 2002, 8, 3086-3092. (d) Guan, Z. J. Polym. Sci. A. Polym. Chem. Ed. 2003, in press.
4. (a) Tempel, D. J.; Johnson, L. K.; Huff, R L.; White, P. S.; Brookhart, M. J. Am. Chem. Soc. 2000, 122, 6686-6700. (b) Gates, D. P.; Svejda, S. A.;. Onate, E.; Killian, C. M.; Johnson, L. K.; White; P. S.; Brookhart, M. Macromolecules 2000, 33, 2320-2334.
5. Xie, T.; McAuley, K. B.; Hsu, J. C. C. and BaconInd, D. W. Eng. Chem. Res. 1994, 33, 449-479.
6. (a) Vogtle, F. Cyclophane Chemistry; John Wiley & Sons: Chichester, 1999. (b) Chiu, S. H.; Stoddart, J. F. J. Am. Chem. Soc. 2002, 124, 4174-4175. (c) Chen, C.-T.; Gantzel, P.; Siegel, J. S.; Baldridge, K. K; English, R. B.; Ho, D. M. Angew Chem Int Ed Engl 1995, 34, 2657-60.
7. (a) Uhrhammer, R.; Black, D. G.; Gardner, T. G.; Olsen, J. D.; Jordan, R. F. J. Am. Chem. Soc. 1993, 115, 8493-8494. (b) Baker, M. V.; Skelton, B. W.; White, A. H.; Williams, C. C. J. Chem. Soc. Dalton Trans. 2001, 111-120. (c) Rondelez, Y.; Bertho, G.; Reinaud, O. Angew. Chem. Int. Ed. 2002, 41, 1044-1046. (d) Seitz, J.; Maas, G. Chem. Comm. 2002, 338-339.
8. Trnka, T. M.; Grubbs, R. H. Acc. Chem. Res. 2001, 34, 18-29.
9. The molecular model was generated by molecular mechanics calculation. First, the lowest energy conformer for the free ligand 6 was searched. Then the nickel bromide complex with the lowest energy conformer of 6 was constructed by importing the bond parameters for the Ni^{II} coordination center from the crystallographic data reported for acyclic N^{II}-□-diimine complex (ref. 5). The rest of the complex was minimized with the coordination center frozen to give the calculated structure.
10. For examples of early metal polymerization catalysts, see: (a) Fink, G.; Mulhaupt, R. and Brintzinger, H. H. Ziegler Catalysts; Springer-Verlag: Berlin, 1995. (b)) Scheirs, J., Kaminsky, W., Eds. Metallocene-Based Polyolefins: Preparation, Properties, and Technology; Wiley: West Sussex, 2000. (c) Coates, G. W.; Waymouth, R. M. Science 1995, 267, 217. (d) Abramo, G. P.; Li, L.; Marks, T. J. J. Am. Chem. Soc. 2002, 125, 13966-13967. (e) Crowther, D. J.; Baenziger, N. C.; Jordan, R. F. J. Am. Chem. Soc. 1991, 113, 1455. (f) Barnhart, R. W. Bazan, G. C. J. Am. Chem. Soc. 1998, 120, 1082-1083. (g) Tian, J.; Hustad, P. D.; Coates, G. W. J. Am. Chem. Soc. 2001, 123, 5134-5135. (h) Coughlin, E. B.; Bercaw, J. E. J. Am. Chem. Soc. i1992, 1-14, 7606.
11. Schimd, M.; Eberhardt, R.; Klinga, M.; Leskela, M.; Rieger, B. Organometallics 2001, 20, 2321-2330.
12. Mohring, V. M.; Fink, G. Angew. Chem. Int. Ed. Engl. 1985,24, 1001-1003.

### APPENDIX B

Materials.

Toluene, dichloromethane and diethyl ether are obtained from the purified solvent system. High-pressure polymerizations were performed in a mechanically stirred 600 mL Parr autoclave. Ultra high pure grade ethylene and propylene gases were purchase from Airgas and used without further purification. 7% Al (wt %) solution of modified methylauminoxane (MMAO) in toluene (d=0.88 g/mL) containing 12% isobutyl groups were purchased from Akzo Nobel. Methyl undecenoate was purchased from Aldrich and was purified by washing with 2N Na₂CO₃, 50% CaCl₂, brine and was further distilled.ⁱ 1-Hexene (99%) and 1-octadecene (90%) were purchased from Aldrich Chemical Co and were degassed using N₂.

General Cosiderations.

The branching of polymers was measured in tetrachloroethane at 120° C. with 10 sec delay time. The degree of branching of the polyethylenes was estimated from the integrals of the methyl, methine and methylene groups as determined by ¹H NMR spectroscopy. Gel permeation chromatography was measured in toluene at room temperature using an HP Agilent GPC vs. polystyrene standard. Thermal analysis was performed on Perkin Elmer Pyris 6 DSC and melt transitions were reported as the temperature at which the endothermic maximum is reached; glass transition temperatures were reported as the temperature at the midpoint of the transition.

General Procedure for 1-Hexene Polymerization (Table 1):

The catalyst was dissolved in toluene followed by addition 1-Hexene. The mixture was heated to the desired temperature and stirred at that temperature for 5 minutes. The MMAO in toluene was added and the reaction was stirred for the specified time. The reaction was quenched with 10% HCl in methanol and the polymer was precipitated with acetone. The polymers were collected and washed with MeOH/HCl, H₂O and acetone. It was then dried at high vacuum at 80° C.

Aliquot Sampling of the Living Polymerization of 1-Hexene (Table 2):

The catalyst 2 was weighed (4.6 mg; 5×10⁻⁶ mol) into a flame-dried flask in a drybox. Toluene (70 ml) was added, dissolving the catalyst to give a green solution. 1-Hexene (35 ml; 280 mmol; 2.66 M) was added to the mixture in a glovebox. The mixture was heated to 75° C. and stirred for 5 minutes. MMAO in toluene was added and the solution turned pinkish. Every 20 minutes for two hours, a 5.0 ml aliquot of the polymerization solution was removed and quenched by addition of 10% HCl in methanol. The polymer was precipitated by addition of acetone. The collected polymer was washed with MeOH/HCl, H₂O and acetone. It was then dried at high vacuum at 80° C. Gel permeation chromatography (toluene, 30° C., polystyrene reference) was used to obtain the molecular weight and dispersity of each polymer aliquot.
1Killian, C. M.; Tempel, D. J.; Johnson, L; K.; Brookhart, M. J. Am. Chem. Soc. 1996, 118, 11664.

2 Gottfried, A. C.; Brookhart, M Macromolecules. 2003, 36, 3085.

3 Gates, D. P.; Svejda, S. A.; Onate, E.; Killian, C. M.; Johnson, L. K.; White, P. S.; Brookhart M. Macromolecules 2000, 33, 2320.

4 Camacho, D. H.; Salo, E. V., Guan, Z. Org. Lett. 2004, 6, 865.

5 Camacho, D. H.; Salo, E. V.; Ziler, J.; Guan, Z. Angew. Chem., Int. Ed. 2004, 43, 1821;

6 S. D. Ittel, L. K. Johnson, M. Brookhart, Chem. Rev. 2000, 100, 1169; b) L. K. Johnson, C. M. Killian, M. Brookhart, J. Am. Chem. Soc. 1995, 117, 6414-6415; c) L. K Johnson, S. Mecking, M. Brookhart, J. Am. Chem. Soc. 1996, 118, 267-268; d) D. P. Gates, S. A. Svejda, E. Onate, C. M. Killian, L. K. Johnson, P. S. White, M. Brookhart Macromolecules 2000, 33, 2320-2334.

7 Liu, W.; Malinoski, J. M.; Brookhart, M. Organometallics, 2002, 21, 2836.

What is claimed is:

1. A composition of matter comprising a metal complex having the following general formula: 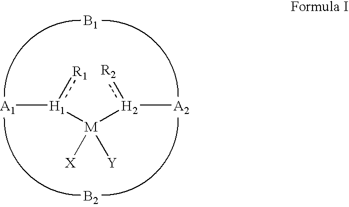
wherein;
B₁ and B₂ may be same or different and are selected from —Ar-T-Ar—, -T-Ar-T- and -T-, wherein Ar is an aromatic ring;
T is a saturated or unsaturated, cyclic or acyclic, chiral or achiral hydrocarbon group with from 1 to 10 carbon atoms and one or more carbons in T may be replaced with one or more heteroatoms or groups selected from O, S, SO, SO₂, NR₃, where R₃ is H, alkyl (C1-4), cycloalkyl (C3-6), aryl, aralkyl and acyl (C2-6); or (SiR4R5)n, where n is 1 or 2 and —Si(R₄R₅)—O— Si(R₄R₅)—, where R4 and R5 may be same or different and are selected from alkyl (C1-4), cycloalkyl (C3-6), aryl and aralkyl;
A₁ and A₂ may be same or different and is a saturated or unsaturated, substituted or unsubstituted, chiral or achiral cyclic ring structure, for example, a cycloalkyl or 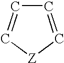
where, Z is selected from O, NR₃, S, CR₆═CR₇, CR₆═N and N═CR₆ and when R₆ and R₇ are H, then the ring may be optionally substituted with one or more substituents, Q, selected from H, alkyl, alkoxy, amino, carboxy, cyano, halo, hydroxy, nitro and trifluoromethyl and R₆ and R₇ may further combine to form a cyclic ring, optionally substituted with one or more heteroatoms selected from O, N and S and may contain at least one doublebond;
H₁ and H₂ are independently selected from any one of the heteroatoms comprising N, P, 0 and S and these heteroatoms can be either in neutral form or exist as the corresponding anion when protons linked to said heteroatoms are removed;
R₁ and R₂, connected to H₁ and H₂ through either a single bond, a double bond or a combination of both, may be same or different and are selected from alkyl, aryl, aralkyl, optionally substituted with alkyl, alkoxy, amino, carboxy, cyano, halo, hydroxy, nitro and trifluoromethyl or R₁ and R₂ may combine through an alkylene or substituted alkylene bridge to form a cyclic ring in case of bidentate ligands (Appendix 1) and one or more methylene groups of said alkylene bridge may be substituted with an heteroatom, G, selected from O, P, S and N or an heterocyclic ring containing such an heteroatom in case of tridendate ligands;
R′ and R″ are alkyl, alkenyl, aryl, aralkyl and cycloalkyl;
X and Y are selected from halogens, pseudo-halogens, carboxylic acid esters, amino, substituted amino, alkoxy or aryloxy group; and
M is a transition group metal ion or a main group metal ion and is selected based on the type of ligand and comprise Fe, Ru, Os, Rh, Ir, Ni, Pd, Pt, Cu, Zn, Al, Ti, Zr, Hf, V, Nb, Ta, Cr, Mo and W.

2. A composition according to claim 1 wherein the aromatic ring AR is selected from the group consisting of: phenyl, furyl, thienyl, pyrrolyl, indolyl, isoindolyl, pyridyl and naphthyl.

3. A composition according to claim 1 wherein B₁, B₂, A₁ and A₂ comprise phenyl rings and the linkages from B₁ to B₂ to A₁ to A₂ to Blare through either the 1,3 or 1,4 positions of each ring moiety.

4. A composition according to claim 1 wherein B₁, B₂, A₁ and A₂ comprise a heterocyclic ring.

5. A composition according to claim 4 wherein the heterocyclic ring has 5 members and wherein the linkages B₁ to B₂ to A₁ to A₂ to B₁ are through any of C₂-C₅.

6. A composition according to claim 4 wherein the heterocyclic ring has 6 members and wherein the linkages B₁ to B₂ to A₁ to A₂ to B₁ are through any of C₂-C6.

7. A composition having General Formula I of claim 1 wherein B₂ is absent, such composition having General Formula II, as follows:

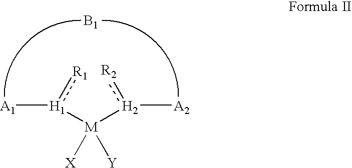

8. A composition according to claim 1 wherein the complex comprises a cyclophane-based Ni^{II}-α-diimine complex.

9. A composition according to claim 8 having Formula III as follows:

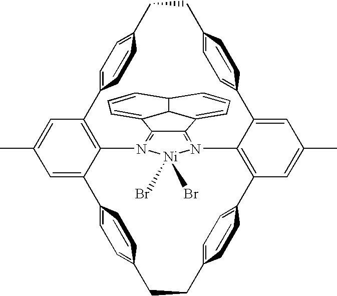

10. A method for preparing an polymer, said method comprising the step of:
A) reacting at least one monomer or prepolymer in the presence of a catalyst comprising a composition according to claim 1.

11. A method according to claim 10 wherein at least a portion of the reaction in Step A occurs at temperatures in excess of approximately 50° C.

12. A method according to claim 10 wherein the polymer is a polyethylene.

13. A method according to claim 10 wherein the polymer is a polyolefin.

14. A method according to claim 10 wherein the method comprises a gas phase polymerization.
